(19) United States
(12) Patent Application Publication
(10) Pub. No.: US 2022/0143453 A1
(43) Pub. Date: May 12, 2022

(54) CLAMPING DEVICE FOR EXERCISE EQUIPMENT

(71) Applicant: Micah Martin, Garner, NC (US)

(72) Inventor: Micah Martin, Garner, NC (US)

(21) Appl. No.: 17/524,382

(22) Filed: Nov. 11, 2021

Related U.S. Application Data
(60) Provisional application No. 63/113,137, filed on Nov. 12, 2020.

(51) Int. Cl. A63B 21/072; F16B 2/06

(52) U.S. Cl. CPC A63B 21/0728; F16B 2/06

(57) ABSTRACT

A clamping device for exercise equipment is disclosed. The clamping device may comprise a collar having a cylindrical inner portion capable of receiving a mounting member. A lever having a first contact point and a second contact point may be provided wherein the first contact point may be pivotably connected to the collar. An arc-shaped member having a first end and a second end may be provided. The first end of the arc-shaped member may be pivotably connected to the collar while the second end may be pivotably connected to the second contact point of the lever. Collar extension fixedly connected to the collars via a plurality of support posts may be provided to enhance the strength of the clamping device. The lever maybe configured to securely engage and disengage the mounting member when actuated between a locked state and an unlocked state.

### CROSS-REFERENCE TO RELATED APPLICATIONS

This application claims benefit of U.S. Provisional Application Ser. No. 63/113,137 entitled “Lock Jaw Collars”, filed Nov. 12, 2020, which is incorporated herein in its entirety.

### TECHNICAL FIELD

The present invention relates to a supporting apparatus for use in weight training equipment. More particularly, the present invention is related to a clamping device for barbells and dumbbells.

### BACKGROUND

There has been a dramatic increase in health consciousness during recent years, as well as the desire to appear fit and trim. Health benefits associated with regular exercise are well known, and many methods of exercise have been developed to achieve this end. Common methods of exercising include home workout gyms, treadmills, bicycling, running, walking, and jogging. Though these methods have proven beneficial, the equipment is costly and not portable, and the person exercising often wishes to utilize weights to supplement running or jogging in order to firm and tone particular muscles. To meet this goal, users often resort to barbells, or other forms of hand-held weights.

Weight training is a common type of strength training for developing the strength and size of skeletal muscles. It utilizes the force of gravity in the form of weighted bars, dumbbells or weight stacks in order to oppose the force generated by muscle through concentric or eccentric contraction. Weight training uses a variety of specialized equipment to target specific muscle groups and types of movement. Sports in which weight training is used are bodybuilding, weightlifting, powerlifting, strongman, highland games, hammer throw, shot put, discus throw, and javelin throw. Many other sports uses strength training as part of their training regimen, notably: American football, baseball, basketball, canoeing, cricket, football, hockey, lacrosse, mixed martial arts, rowing, rugby league, rugby union, track and field, boxing and wrestling.

Weight training usually requires different types of equipment, most commonly kettle bells, dumbbells, barbells, weight plates, and weight machines. Various combinations of specific exercises, machines, dumbbells, and barbells allow trainees to exercise body parts in numerous ways.

A barbell is a piece of exercise equipment used in weight training, bodybuilding, weightlifting and powerlifting, consisting of a long bar, usually with weights attached at each end. Barbells range in length from 1.2 meters (4 ft.) to above 2.4 meters (8 ft.), although bars longer than 2.2 meters (7.2 ft.) are used primarily by powerlifters and are not commonplace. The central portion of the bar varies in diameter from 25 millimeters (0.98 in) to 50 millimeters (1.96 in) (e.g., Apollon's Axle), and is often engraved with a knurled crosshatch pattern to help lifters maintain a solid grip. Weight plates slide onto the outer portions of the bar to increase or decrease the desired total weight. Collars are used to prevent plates from moving outward unevenly so that the lifter does not experience uneven force.

Standard collars can be of any material, usually metal, and they can weigh up to 2.5 kilograms (5.5 lb) each for both men and women. Metal collars with a threaded bolt perpendicularly employed to clamp the collar onto the bar are among the forms of temporary retention devices. These metal collars can scar the bar and are typically weighty. A user must, therefore, figure the weight of two such assemblies, then add this to achieve the total weight lifted. Another collar assembly includes a heavy hinged collar with wing nut for tightening the collar around the bar, once the collar is assembled in place. Such assemblies usually include a material on the internal diameter of the device which is provided to resist slippage.

These materials are often inadequate against slippage and require that the collars be severely tightened. These collars, too, are weighty. Still other collars do not fully open but provide for temporary increase in diameter in order for the collar to be slid onto the bar, the collars then tightened. All of the above types of collars are, to most users, so weighty and clumsy that their use is often ignored, which can allow weights to slide out of position, changing the bar's center of mass, or even fully slide off, and thereby endanger a user or anyone proximal to use.

Hence, it will be advantageous to provide an apparatus that is easy to carry and use and can securely support multiple combination of weights that may be added to barbells or dumbbells. The apparatus should allow easy connection and removal from standard bars.

### SUMMARY OF THE INVENTION

In light of the disadvantages mentioned in the previous section, the following summary is provided to facilitate an understanding of some of the innovative features unique to the present invention and is not intended to be a full description. A full appreciation of the various aspects of the invention can be gained by taking the entire specification and drawings as a whole.

Embodiments of the present disclosure proposes a clamping device for mounting members such as barbells or dumbbells. The clamping device may comprise a collar having a first section and a second section. The first and second sections of the collar may be connected to each other to form a cylindrical inner portion. The cylindrical inner portion may be capable of receiving a mounting member such as a dumbbell rod or a barbell. Further, a lever having a first contact point and a second contact point may be provided. Herein, the first contact point may be pivotably connected to the first section of the collar. Furthermore, an arc-shaped member having a first end and a second end may be provided. The first end of the arc-shaped member may be pivotably connected to the second section of the collar and the second end of the arc-shaped member may be pivotably connected to the second contact point of the lever. A first collar extension fixedly connected to the first section of the collar and a second collar extension fixedly connected to the second section of the collar is provided to enhance the strength of the collar. Herein, the fixed connections between the first and second sections of the collar and the first and second collar extensions may comprise a plurality of support posts with each of the plurality of support posts being encapsulated with compression springs. The lever maybe configured to securely engage the mounting member placed within the cylindrical inner portion when actuated to a locked position by increasing the grip delivered on the mounting member by the collar and collar extensions. Further, the lever may be configured to disengage the mounting member from the cylindrical inner portion when actuated to an unlocked position by releasing the grip delivered on the mounting member by the collar and collar extensions.

This summary is provided merely for purposes of summarizing some example embodiments, to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following detailed description and figures.

The abovementioned embodiments and further variations of the proposed invention are discussed further in the detailed description.

### BRIEF DESCRIPTION OF THE DRAWINGS

FIGS. 1-5 are exemplary perspective views of the clamping device according to the embodiments of the present disclosure.

FIG. 6 depicts exemplary views of the first and second sections of the collar of the clamping device according to the embodiments of the present disclosure.

FIG. 7 depicts exemplary views of the collar extensions and the arc-shaped member of the clamping device according to the embodiments of the present disclosure.

FIG. 8 depicts exemplary views of the lever of the clamping device according to the embodiments of the present disclosure.

FIG. 9 depicts exemplary views of a grip padding, a support post, and a compression spring of the clamping device according to the embodiments of the present disclosure.

The drawings described herein are for illustration purposes only and are not intended to limit the scope of the present subject matter in any way.

### DETAILED DESCRIPTION

According to the embodiments of the present disclosure, a clamping device for mounting members such as barbells or dumbbell rods is disclosed. The clamping device may comprise a collar having a first section and a second section connected to each other to form a cylindrical inner portion. The cylindrical inner portion may be capable of receiving a mounting member such as a dumbbell rod or a barbell. A lever having a first contact point and a second contact point may be used to engage and disengage the clamp when in use. The first contact point of the lever may be pivotably connected to the first section of the collar.

An arc-shaped member having a first end and a second end may be provided for securing the lever in an engaged or disengaged state. The first end of the arc-shaped member may be pivotably connected to the second section of the collar and the second end of the arc-shaped member may be pivotably connected to the second contact point of the lever. A pair of collar extensions may be provided to further enhance the working of the collar. The collar extensions comprise a first collar extension fixedly connected to the first section of the collar and a second collar extension fixedly connected to the second section of the collar.

The fixed connections between the first and second sections of the collar and the first and second collar extensions may comprise a plurality of support posts with each of the plurality of support posts being encapsulated with compression springs.

The lever maybe configured to securely engage the mounting member placed within the cylindrical inner portion when actuated to a locked position by increasing the grip delivered on the mounting member by the collar and collar extensions. Further, the lever may be configured to disengage the mounting member from the cylindrical inner portion when actuated to an unlocked position by releasing the grip delivered on the mounting member by the collar and collar extensions.

In the following description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments maybe utilized and that changes may be made without departing from the scope of the present invention. The following detailed description is, therefore, not to be taken in a limited sense, and the scope of the present invention is defined only by the appended claims.

The specification may refer to “an”, “one” or “some” embodiment(s) in several locations. This does not necessarily imply that each such reference is to the same embodiment(s), or that the feature only applies to a single embodiment. A single feature of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements and/or components, but do not preclude the presence or addition of one or more other features integers, steps, operations, elements, components, and/or groups thereof. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present disclosure proposes an apparatus that may be used as a barbell collar/clamp. The terms “collar” and “clamp” may be used interchangeably throughout this document. The terms “weights”, “plates”, and “disks” may be used interchangeably throughout this document. The terms used herein do not change the scope of the present subject matter.

In the foregoing sections, some features are grouped together in a single embodiment for streamlining the disclosure. This method of disclosure is not to be interpreted as reflecting an intention that the disclosed embodiments of the present disclosure must use more features than are expressly recited in each claim. Rather, as the following claims reflect, the inventive subject matter lies in less than all features of a single disclosed embodiment. Thus, the following claims are hereby incorporated into the detailed description, with each claim standing on its own as a separate embodiment.

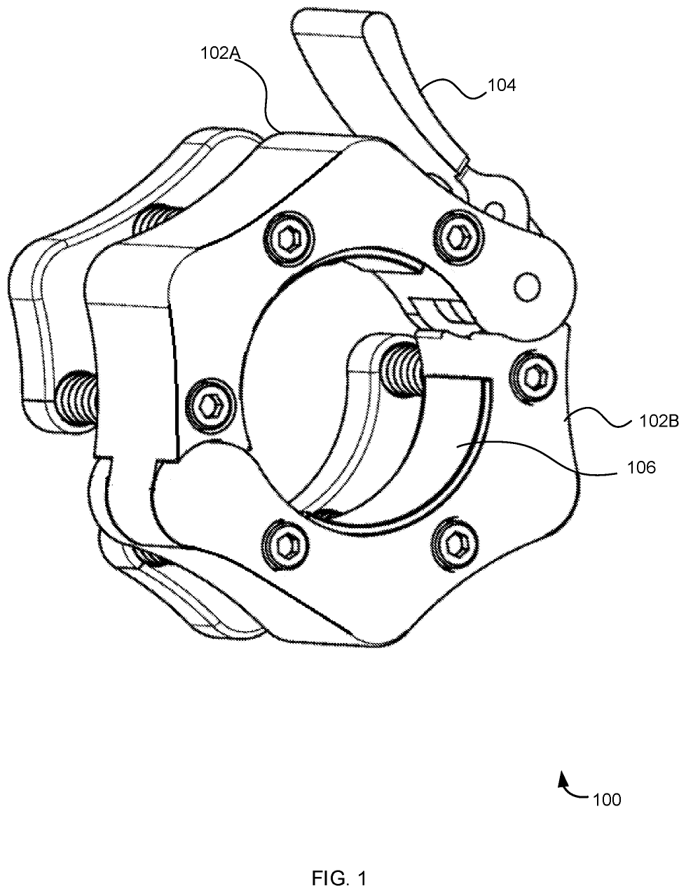

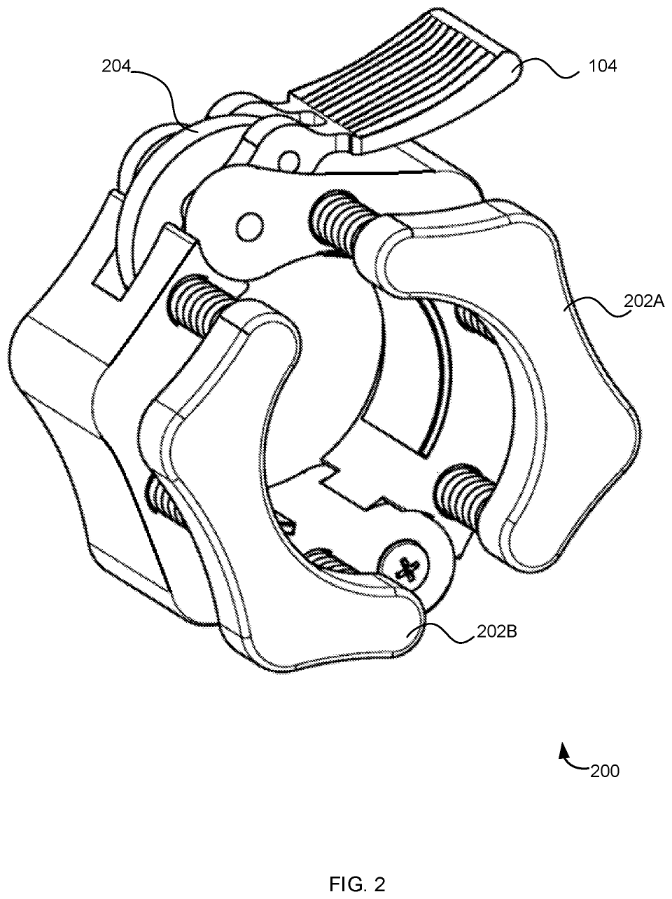

Before explaining the working of the clamping device in detail, it is pertinent to refer to the figures enclosed with this disclosure. Referring to the figures, FIGS. 1-5 are exemplary perspective views 100-500 of the clamping device according to the embodiments of the present disclosure. FIG. 1 depicts a side perspective view 100 of the clamping device. The clamping device includes a collar which is comprised of a first section 102A and a second section 102B. The first and second sections of the collar are connected to each other at two points as described in the figure to form a cylindrical inner portion capable of receiving a barbell or a dumbbell rod. As described in the figure, the first section 102A and the second section 102B are connected at two points wherein one end is connected using a standard pin-type hinge connector while the other end is connected using a locking mechanism. The primary components of the locking mechanism include a lever 104 and an arc-shaped member 204 (referenced in FIG. 2).

FIG. 2 depicts a second side perspective view 200 of the clamping device. The extended collars of the clamping device are referenced by 202A and 202B wherein 202A is the first collar extension and 202B is a second collar extension. The first collar extension 202A is fixedly connected to the first section 102A of the collar while the second collar extension 202B is fixedly connected to the second section 102B of the collar as depicted in the figure.

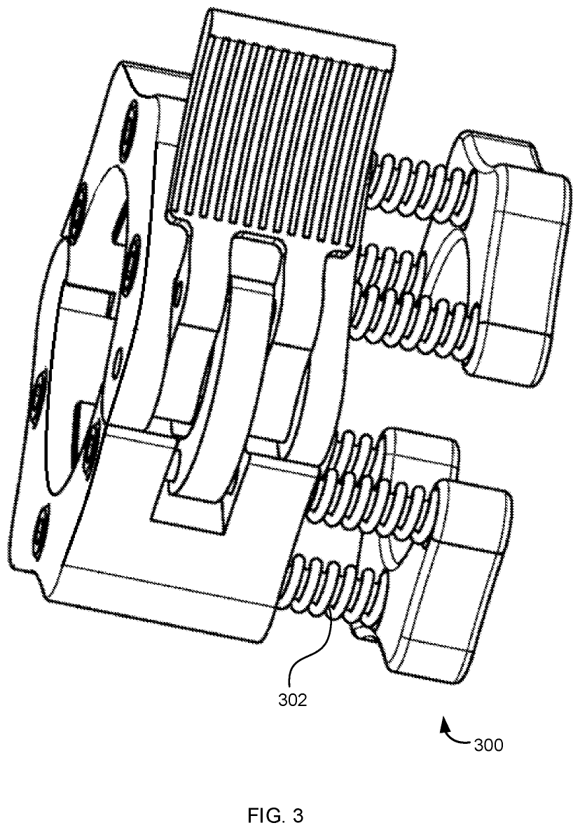

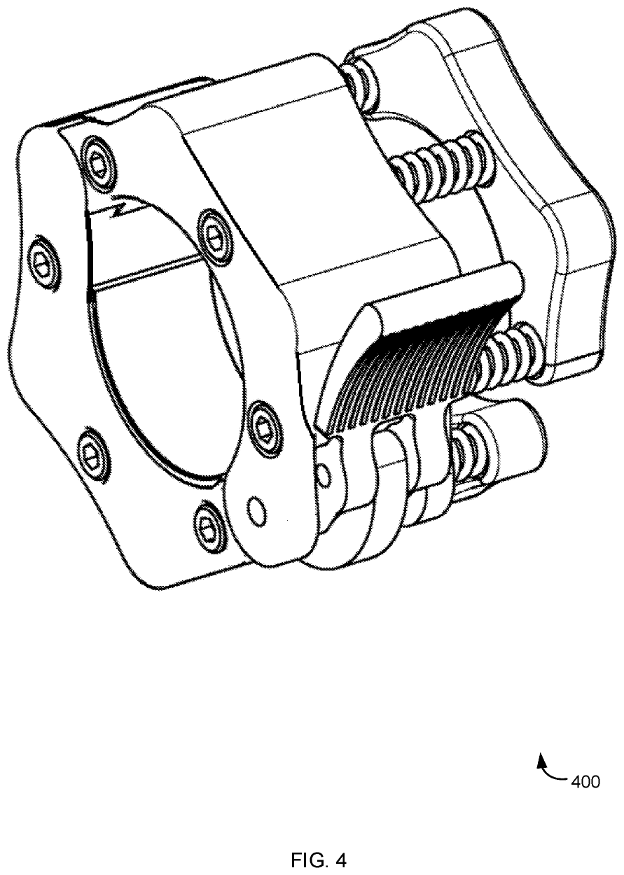

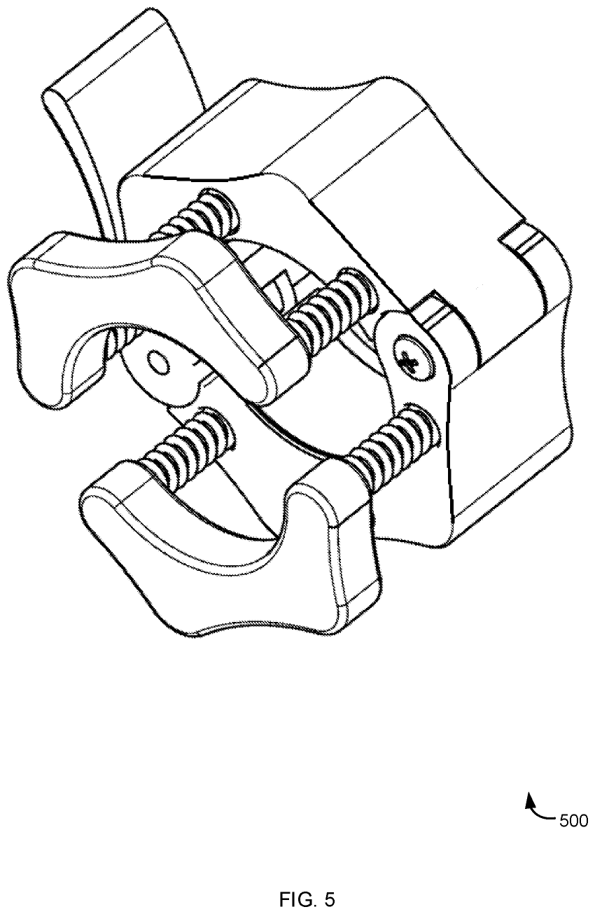

FIG. 3 depicts a top perspective view 300 of the clamping device. A plurality of supports that fixedly connect the first section of the collar 102A to the first collar extension 202A and the second section of the collar 102B to the second collar extension 202B are depicted by 302. The support 302 may include a combination of support posts and compression springs as depicted in the figures. FIG. 4 is another top perspective view 400 and FIG. 5 is yet another top perspective view 500 of the clamping device according to the embodiments of the present disclosure.

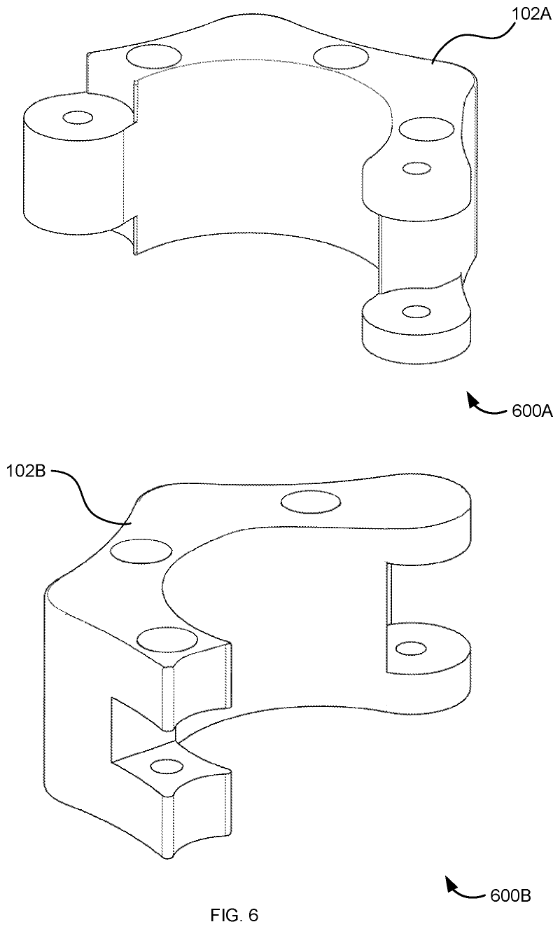

FIG. 6 depicts exemplary views 600A and 600B of the first and second sections of the collar of the clamping device according to the embodiments of the present disclosure. The first section of the collar 102A and the second section of the collar 102B are slightly different in their shapes (more specifically, their connecting ends). While one of the ends of the first and second sections of the clamping device are connected using a standard hinge connection, the other side has a locking mechanism comprising hinge connections as well as lever and pull bar mechanisms.

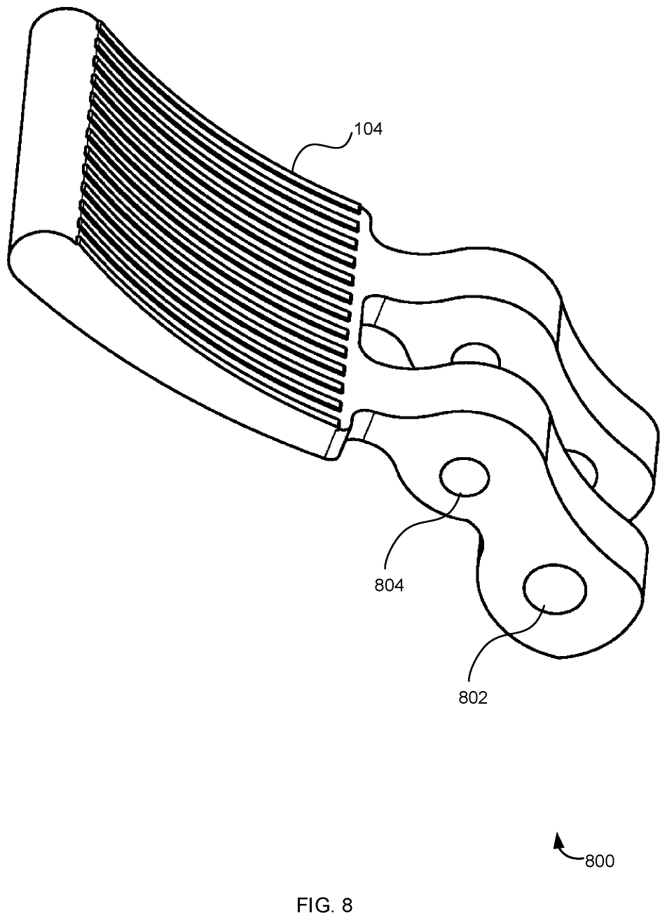

Herein, the lever 104 may have two contact points (802 and 804 of FIG. 8) wherein the first contact point 802 may be pivotably connected to the first section 102A of the collar. The second contact point 804 of the lever may be pivotably connected to one of the ends of the arc-shaped member 204 which may act as a pull bar. The other end of the arc-shaped member 204 may be connected to the second section 102B of the collar. This assembly allows a lever and pull bar based locking mechanism for securely locking the collar and associated collar extensions.

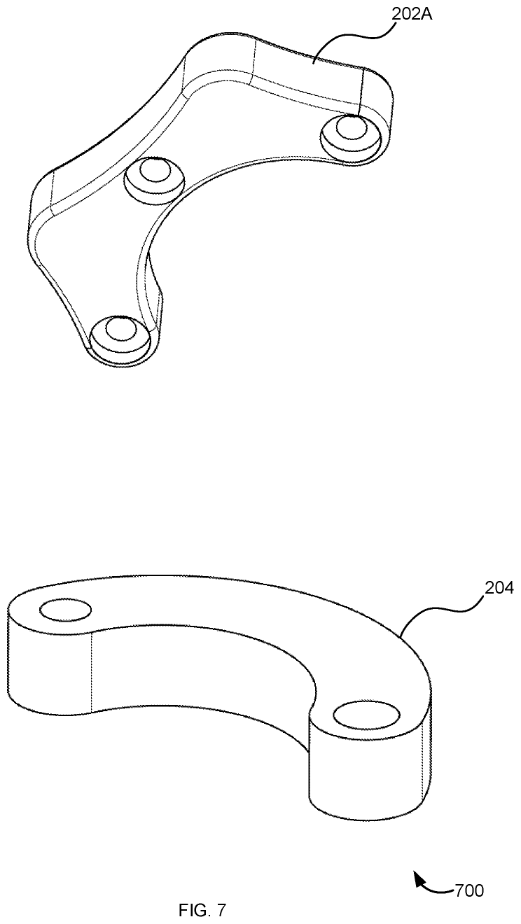

FIG. 7 depicts exemplary views 700A and 700B of the collar extension and the arc-shaped member of the clamping device according to the embodiments of the present disclosure. FIG. 8 depicts exemplary view of the lever 104 of the clamping device according to the embodiments of the present disclosure. Herein the connection points 802 and 804 may be pivotably connected to the first section of the collar 102A and the arc-shaped member 204 of the clamping device respectively as depicted in FIGS. 1-5. The assembly provided herein allows the locking mechanism to securely close and tighten the collar when placed in a closed configuration. The arc-shaped member may have a first end and a second end. The first end of the arc-shaped member maybe pivotably connected to the second section of the collar 102B and the second end of the arc-shaped member maybe pivotably connected to the second contact point 804 of the lever 104. The arc-shaped member 204 secures the lever 104 from releasing erroneously when the lever is configured to the locked position or the unlocked position. A user will have to manually actuate the lever 104 by applying a reasonable amount of force to lock and unlock the clamping device. This mechanism prevents mishaps caused by conventional barbell clamps.

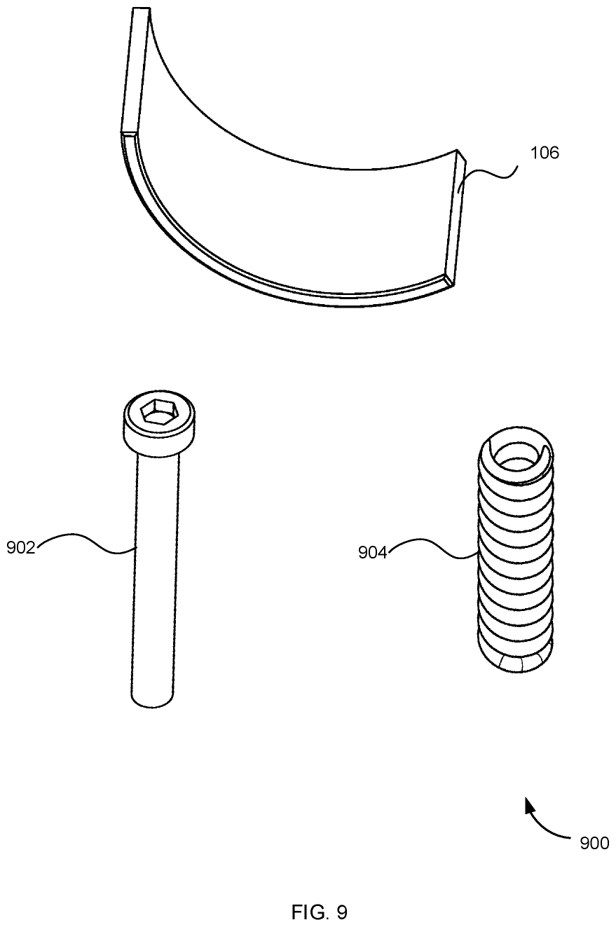

FIG. 9 depicts exemplary views 900 of the grip padding 106, a post 902, and a compression spring 904 of the clamping device according to the embodiments of the present disclosure. The fixed connections between the first and second sections of the collar and the first and second collar extensions comprises of a plurality of supports 302 wherein each of the plurality of supports 302 comprises substantially cylindrical posts 902 encapsulated with compression springs 904.

The lever 104 may be configured to securely engage the mounting member (a barbell or a dumbbell rod) placed within the cylindrical inner portion when actuated to a locked position. This is achieved by increasing the grip delivered on the mounting member by the collar and collar extensions. Further, the mounting member may be disengaged from the cylindrical inner portion when the lever 104 is actuated to an unlocked position. When the lever 104 is actuated to an unlocked configuration, the collar and the collar extensions lose grip over the mounting member. The cylindrical inner portion may be tightened and loosened upon locking and unlocking the clamping device thereby gripping and releasing the mounting member placed within the cylindrical inner portion.

The cylindrical inner portion of the collar maybe enhanced with grip padding 106. The grip padding 106 enhances the grip provided by the clamp when the mounting member is locked into the clamp. The material used as the grip padding 106 may include rubber-like materials or any related materials that enhance gripping as understood by a person skilled in the art. The clamping device disclosed herein may be used to secure one or more weight plates to the mounting member. Weight plates may include plates having different shapes, sizes, and masses. The weight plates may have an opening to dock them into a slot provided on the mounting member. The clamping device maybe fixed beside the weight plates (in both sides or in one side if the other side of the slot has an inbuilt stopper) to secure the weight plates onto the mounting member. The clamping device prevents the weight plates from moving freely on the mounting member thereby avoiding accidents during workout sessions.

The collar extensions 202A and 202B and the plurality of supports 302 having support posts 902 encapsulated with compression springs 904 may act as a fail-safe and/or secondary grip to the weight plates. The compression sprigs 904 may be in a loaded state when installed to the plurality of supports 302. The plurality of supports 302 along with the collar extensions 202A and 202B pushes back load to the one or more weight plates thereby reducing the load on the collar. Unlike a conventional clamp that resists the load/force received on it, the clamping device disclosed herein pushes back the load instead of resisting it by means of the compression springs and support posts. Further, the load is evenly distributed throughout the collar, the collar extensions, and the plurality of supports thereby reducing the load on the collar itself. The assembly disclosed herein thereby provides a foolproof mechanism for securing weight plates to barbells and dumbbell rods.

In a related embodiment of the present disclosure, a method for securing weight plates to a mounting member is disclosed. The method includes placing one or more weights plates within a slot provided on the mounting member and placing a collar in an unlocked configuration beside the weight plates to prevent the weight plates from freely sliding on the mounting member. The collar further comprises a first section and a second section, wherein the first and second sections of the collar are connected to each other to form a cylindrical inner portion capable of receiving a mounting member therethrough. Further, a lever having a first contact point and a second contact point wherein the first contact point is pivotably connected to the first section of the collar is provided. An arc-shaped member having a first end and a second end, wherein the first end of the arc-shaped member is pivotably connected to the second section of the collar and the second end of the arc-shaped member is pivotably connected to the second contact point of the lever is provided. Further, a first collar extension fixedly connected to the first section of the collar and a second collar extension fixedly connected to the second section of the collar is provided. Herein, the fixed connections between the first and second sections of the collar and the first and second collar extensions comprises of a plurality of support posts with each of the plurality of connection posts encapsulated with compression springs. Said lever is configured to securely engage the mounting member placed within the cylindrical inner portion when actuated to a locked position by increasing the grip delivered on the mounting member by the collar and collar extensions, and disengage the mounting member from the cylindrical inner portion when actuated to an unlocked position by releasing the grip delivered on the mounting member by the collar and collar extensions.

The clamping device may be manufactured using materials including steel, aluminium, aluminium alloy, billet aluminium, carbon fibre, or the like, as understood by a person skilled in the art.

The features and advantages listed in the previous sections of the document illustrate the various technical advancements provided by the present invention in solving the technical problems faced in this field of invention. It may be noted that the present disclosure covers obvious modifications of the abovementioned ideas and concepts that are similar and related as understood by a person ordinarily skilled in the art.

It may be noted that the above-described examples of the present solution are for the purpose of illustration only. Although the solution has been described in conjunction with a specific embodiment thereof, numerous modifications may be possible without materially departing from the teachings and advantages of the subject matter described herein. Other substitutions, modifications, and changes may be made without departing from the spirit of the present solution. All the features disclosed in this specification (including any accompanying drawings), and/or all of the steps of any method or process so disclosed, may be combined in any combination, except combinations where at least some of such features and/or steps are mutually exclusive.

The terms “include,” “have,” and variations thereof, as used herein, have the same meaning as the term “comprise” or an appropriate variation thereof. Furthermore, the term “based on”, as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter.

What is claimed is:

1. A clamping device comprising:
a collar having a first section and a second section, wherein the first and second sections of the collar are connected to each other to form a cylindrical inner portion capable of receiving a mounting member therethrough
a lever having a first contact point and a second contact point wherein the first contact point is pivotably connected to the first section of the collar;
an arc-shaped member having a first end and a second end, wherein the first end of the arc-shaped member is pivotably connected to the second section of the collar and the second end of the arc-shaped member is pivotably connected to the second contact point of the lever; and
a first collar extension fixedly connected to the first section of the collar and a second collar extension fixedly connected to the second section of the collar, wherein the fixed connections between the first and second sections of the collar and the first and second collar extensions comprises of a plurality of support posts with each of the plurality of support posts being encapsulated with compression springs;
wherein said lever is configured to securely engage the mounting member placed within the cylindrical inner portion of the collar when actuated to a locked position by increasing the grip delivered on the mounting member by the collar and collar extensions, and disengage the mounting member from the cylindrical inner portion of the collar when actuated to an unlocked position by releasing the grip delivered on the mounting member by the collar and collar extensions.

2. The clamping device of claim 1, wherein the cylindrical inner portion of the collar is padded with a gripping material.

3. The clamping device of claim 1, wherein the clamping device is used to secure one or more weight plates to the mounting member.

4. The clamping device of claim 3, wherein the collar extensions and the plurality of support posts encapsulated with compression springs pushes back load to the one or more weight plates thereby reducing the load on the collar.

5. The clamping device of claim 4, wherein the mounting member is a barbell or a dumbbell rod.

6. The clamping device of claim 1, wherein the arc-shaped member prevents the lever from disengaging when the lever is engaged in locked position or unlocked position.

7. A method for securing weight plates to a mounting member comprising:
placing one or more weights plates within a slot provided on the mounting member;
placing a collar in an unlocked configuration beside the weight plates to prevent the weight plates from freely sliding on the mounting member, said collar further comprising:
a first section and a second section, wherein the first and second sections of the collar are connected to each other to form a cylindrical inner portion capable of receiving a mounting member therethrough;
a lever having a first contact point and a second contact point wherein the first contact point is pivotably connected to the first section of the collar;
an arc-shaped member having a first end and a second end, wherein the first end of the arc-shaped member is pivotably connected to the second section of the collar and the second end of the arc-shaped member is pivotably connected to the second contact point of the lever; and
a first collar extension fixedly connected to the first section of the collar and a second collar extension fixedly connected to the second section of the collar, wherein the fixed connections between the first and second sections of the collar and the first and second collar extensions comprises of a plurality of support posts with each of the plurality of connection posts encapsulated with compression springs;
wherein said lever is configured to securely engage the mounting member placed within the cylindrical inner portion when actuated to a locked position by increasing the grip delivered on the mounting member by the collar and collar extensions, and disengage the mounting member from the cylindrical inner portion when actuated to an unlocked position by releasing the grip delivered on the mounting member by the collar and collar extensions.

8. The method of claim 7, wherein the cylindrical inner portion of the collar is padded with a gripping material.

9. The method of claim 7, wherein the clamping device is used to secure one or more weight plates to the mounting member.

10. The method of claim 9, wherein the collar extensions and the plurality of support posts encapsulated with compression springs pushes back load to the one or more weight plates thereby reducing the load on the collar.

11. The method of claim 10, wherein the mounting member is a barbell or a dumbbell rod.

12. The method of claim 7, wherein the arc-shaped member prevents the lever from disengaging when the lever is engaged in locked position or unlocked position.
